(19) United States
(12) Patent Application Publication
(10) Pub. No.: US 2013/0207948 A1
(43) Pub. Date: Aug. 15, 2013

(54) TRANSPARENT DISPLAY APPARATUS AND METHOD FOR OPERATING THE SAME

(71) Applicants: GwanYoung NA, Osan-si (KR); Kwang-Hyun KIM, Gunpo-si (KR); Sang-Jae KIM, Seongnam-si (KR); Ji-Hoon KIM, Hwaseong-si (KR); Taeho KIM, Asan-si (KR); NaYoung SHIN, Seoul (KR); Seunghee LEE, Seoul (KR); Daewon KIM, Dongducheon-si (KR); Seungbeom PARK, Seoul (KR); Beong-hun BEON, Cheonan-si (KR)

(72) Inventors: GwanYoung NA, Osan-si (KR); Kwang-Hyun KIM, Gunpo-si (KR); Sang-Jae KIM, Seongnam-si (KR); Ji-Hoon KIM, Hwaseong-si (KR); Taeho KIM, Asan-si (KR); NaYoung SHIN, Seoul (KR); Seunghee LEE, Seoul (KR); Daewon KIM, Dongducheon-si (KR); Seungbeom PARK, Seoul (KR); Beong-hun BEON, Cheonan-si (KR)

(73) Assignee: SAMSUNG DISPLAY CO., LTD., Yongin-City (KR)

(21) Appl. No.: 13/524,267

(22) Filed: Jun. 15, 2012

(30) Foreign Application Priority Data
Feb. 15, 2012 (KR) 10-2012-0015487

(51) Int. Cl. G06F 3/038; G09G 5/10

(52) U.S. Cl. 345/207

(57) ABSTRACT

A transparent display apparatus includes a transparent image panel including a plurality of sub-pixels, a data driver to apply a data signal to the sub-pixels, a gate driver to apply a gate driving signal to the sub-pixels, a timing controller to control the data driver and the gate driver in response to a first image signal, and a window disposed on a surface of the transparent image panel and including a plurality of light sensors arranged thereon. Each of the light sensors senses an external incident light and applies a sensing signal corresponding to the sensed external incident light to the timing controller, and the timing controller applies a second image signal to the data driver on the basis of the sensing signal and the first image signal.

### CROSS-REFERENCE TO RELATED APPLICATION

This application claims priority from and the benefit of Korean Patent Application No. 10-2012-0015487, filed on Feb. 15, 2012, the entire disclosure of which is incorporated herein by reference for all purposes.

### BACKGROUND

1. Field

The present disclosure relates to a transparent display apparatus.

2. Discussion of the Background

A transparent display apparatus may maintain its transparent state while displaying a text or image. In general, the transparent display apparatus may be manufactured by forming a transparent electronic device on a substrate that may be made of transparent material, such as a glass.

The transparent display apparatus may have a wide range of use as a tool for delivering information and communication, such as advertising, publicity, and the like. For example, the transparent display apparatus may be used as an information window, electronic-boards, at the like, at retail stores or home.

However, clarity of images displayed through the transparent display apparatus may be degraded based on certain surroundings. Therefore, the transparent display apparatus may have difficulty distinctly displaying images in select surroundings.

### SUMMARY

Exemplary embodiments of the present invention provide a transparent display apparatus and method for more clearly displaying images.

Additional features of the invention will be set forth in the description which follows, and in part will be apparent from the description, or may be learned by practice of the invention.

Exemplary embodiments of the present invention provide a transparent display apparatus including a transparent image panel including a plurality of sub-pixels, a data driver configured to apply a data signal to the sub-pixels, a gate driver configured to apply a gate driving signal to the sub-pixels, a timing controller configured to control the data driver and the gate driver in response to a first image signal, and a window disposed on a surface of the transparent image panel and including a plurality of light sensors arranged thereon, in which at least one of the light sensors senses an external incident light and applies a sensing signal corresponding to the sensed external incident light to the timing controller, and the timing controller applies a second image signal to the data driver based on the sensing signal and the first image signal.

Exemplary embodiments of the present invention provide a method for distinguishing a display object provided on a transparent display apparatus including receiving a sensing signal corresponding to an external incident light from a plurality of light sensors, converting the sensing signal to a gray scale signal using a processor, receiving a first image signal is received, determining a display object from the first image signal, and converting the first image signal to a second image signal based on a gray scale value of the display object and the gray scale signal.

Exemplary embodiments of the present invention provide a method for displaying an object on a transparent display, the method including receiving a first image signal comprising information for displaying an object, sensing a light incident on a rear surface of the transparent display, comparing a visual characteristic of the object to be displayed with a visual characteristic of the light incident on the rear surface of the display, modifying the visual characteristic of the object to be displayed when the visual characteristic of the object to be displayed is equal to or within a threshold amount of the visual characteristic of the light incident on the rear surface of the display, and displaying the object using the modified visual characteristic.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view showing a transparent display apparatus according to an exemplary embodiment of the present invention.

FIG. 2 is a block diagram showing a transparent display apparatus shown in FIG. 1.

FIG. 3 is a view showing light sensors arranged on a front window and a rear window shown in FIG. 2.

FIG. 4 is a view showing light sensors attached to a rear window shown in FIG. 3.

FIG. 5A, FIG. 5B, FIG. 5C, and FIG. 5D are views showing incident angles of external lights sensed by a second-type light sensor, a third-type light sensor, a fourth-type light sensor, and a fifth-type light sensor shown in FIG. 4.

FIG. 6 is a view showing a display object displayed through a transparent display apparatus.

FIG. 7 is a plan view showing sub-pixels of a transparent image panel corresponding to a portion of the display object shown in FIG. 6.

FIG. 8 is a flow chart showing an operation of a timing controller according to an exemplary embodiment of the present invention.

FIG. 9 is a flow chart showing an operation of a timing controller according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity.

It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Further, it will be understood that when an element is referred to as being “on” or “connected to” or “coupled to” another element, it can be directly on, directly connected to, or directly coupled to the other element, or intervening elements may be present. In contrast, if an element is referred to as being “directly on” or “directly connected to” or “directly coupled to” another element, no intervening elements are present.

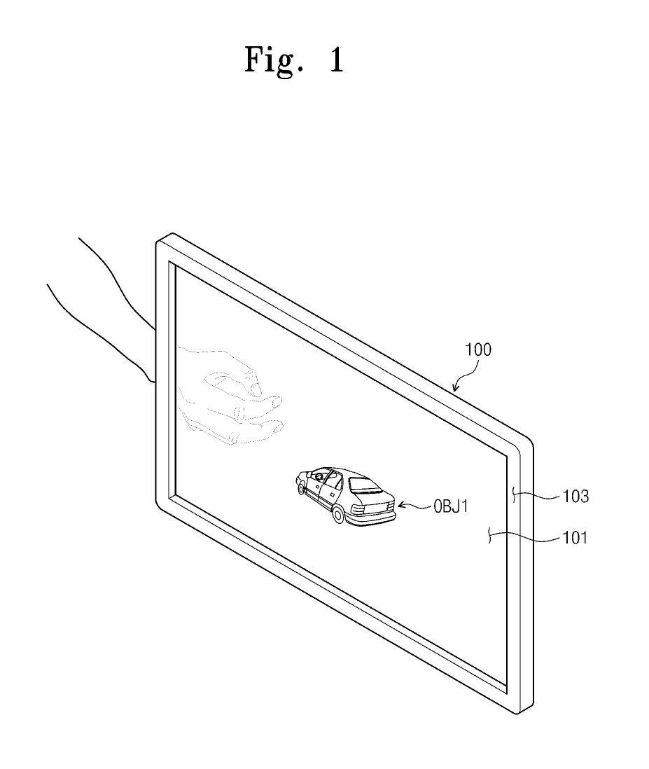

FIG. 1 is a perspective view showing a transparent display apparatus according to an exemplary embodiment of the present invention.

Referring to FIG. 1, a transparent display apparatus 100 includes a front window 101 and a vessel 103 that surrounds the front window 101. The transparent display apparatus 100 may allow light to travel in a frontal direction in which the front window 101 is disposed to display an image. Although not shown in FIG. 1, a transparent image panel and a rear window may be disposed at a rear of the front window 101. For instance, the transparent image panel may include, without limitation, a liquid crystal display panel, and thus the transparent display apparatus 100 may further include a backlight unit (not shown). The transparent image panel may display an image using the light provided from the backlight unit. To this end, the transparent image panel may include a liquid crystal layer, a thin film transistor substrate, and a color filter substrate facing the thin film transistor while interposing the liquid crystal layer there between. However, the transparent image panel should not be limited to the liquid crystal display panel. More specifically, the transparent image panel may include various display panels, such as a plasma display panel, an electro-luminescent display panel, a vacuum fluorescent display panel, and the like.

The front window 101 may protect the transparent display apparatus 100 from external sources that may damage the display apparatus and transmits light exiting from the transparent display apparatus 100 to allow the image produced by the transparent display apparatus 100 to be perceived externally. For example, the front window 101 may be made of a material having superior impact resistance and light transmissivity, such as a plastic material (acrylic) or a glass material.

The transparent display apparatus 100 may display an image, such as a display object OBJ1 and a background image behind the transparent display apparatus 100 to a viewer. Accordingly, if a person puts their hand behind the transparent display apparatus 100, as FIG. 1 shows, the hands may be visible through the transparent display apparatus 100.

If the background of the transparent display apparatus 100 is provided in a white color and the display object OBJ1 is provided in a similar white color, the viewer may have some difficulty recognizing the display object OBJ1 overlapped with the white background. As described above, in the case that the color of the background of the transparent display apparatus 100 is similar to the color of the display object OBJ1, the transparent display apparatus 100 may change a gray scale value of image data corresponding to an outline or a portion of the display object OBJ1. Accordingly, the display object OBJ1 may be more distinctly recognized from the background.

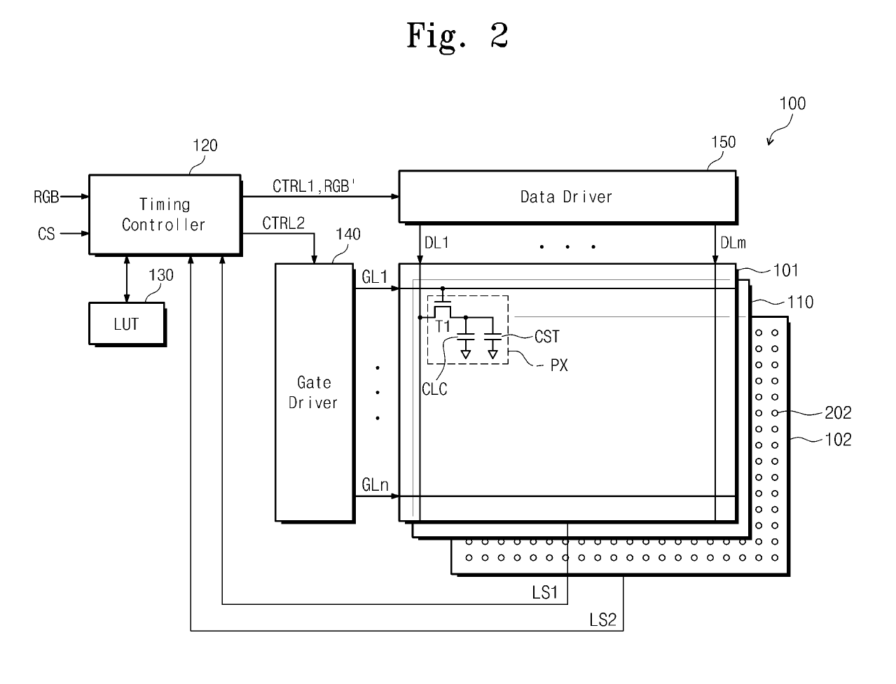

FIG. 2 is a block diagram showing the transparent display apparatus shown in

FIG. 1.

Referring to FIG. 2, the transparent display apparatus 100 includes a transparent image panel 110, a front window 101, a rear window 102, a timing controller 120, a look-up table 130, a gate driver 140, and a data driver 150.

The timing controller 120 receives a first image signal RGB and a plurality of control signals CS. The timing controller 120 may convert the first image signal RGB (e.g., image of a display object) into a second image signal RGB′ and apply the second image signal RGB′ to the data driver 150. In addition, the timing controller 120 may apply a data control signal CTRL1 (e.g., an output start signal, a horizontal start signal, and etc.) to the data driver 150 and apply a gate control signal CTRL2 (e.g., a vertical start signal, a clock signal, and etc.) to the gate driver 140.

The gate driver 140 may sequentially output a gate driving signal to gate lines GL1 to GLn in response to the gate control signal CTRL2 provided from the timing controller 120.

The data driver 150 may convert the second image signal RGB′ into a data voltage in response to the data control signal CTRL1 provided from the timing controller 130 and apply the data voltage to data lines DL1 to DLm.

The transparent image panel 110 includes the data lines DL1 to DLm to which the data voltages may be applied, the gate lines GL1 to GLn to which the gate signals may be applied, and a plurality of sub-pixels PX respectively arranged in areas defined by the data lines DL1 to DLm and the gate lines GL1 to GLn. The sub-pixels PX may have similar structure and operation.

One or more sub-pixel PX may include a thin film transistor T1, a pixel electrode CLC, and a storage capacitor CST. The thin film transistor T1 may include a gate electrode connected to a corresponding gate line of the gate lines GL1 to GLn, a source electrode connected to a corresponding data line of the data lines DL1 to DLm, and a drain electrode connected to the pixel electrode CLC and the storage capacitor CST.

The gate lines GL1 to GLn are connected to the gate driver 140 and the data lines DL1 to DLm are connected to the data driver 140. The gate lines GL1 to GLn may receive gate signals from the gate driver 140 and the data lines DL1 to DLm may receive the data voltages from the data driver 150.

Accordingly, the thin film transistor T1 in one or more sub-pixel PX may be turned on in response to the gate signal provided through the corresponding gate line, and the data voltage provided to the corresponding data line may be applied to the pixel electrode CLC through the thin film transistor T1 that is turned on.

The front window 101 may be disposed at a frontal portion of the transparent image panel 110 and the rear window 102 may be disposed at a rear portion of the transparent image panel 110. The front window 101 may include front light sensors 201 that may be arranged thereon and the rear window 102 may include rear light sensors 202 arranged thereon. The front light sensors 201 arranged on the front window 101 may sense an external incident light and apply a first sensing signal LS1 corresponding to the sensed external incident light to the timing controller 120. The rear light sensors 202 arranged on the rear window 102 may sense an external incident light and apply a second sensing signal LS2 corresponding to the sensed external incident light to the timing controller 120. The first sensing signal LS1 and the second sensing signal LS2, which may be applied to the timing controller 120 from the front light sensor 201 and the rear light sensor 202, include information related to the external incident light, such as brightness, color, and the like.

The timing controller 120 may output the second image signal RGB′ based on the first sensing signal LS1 and the second sensing signal LS2 and the first image signal RGB. The process of the timing controller 120 outputting the second image signal RGB′ will be described in more detail later.

The look-up table 130 may be used to convert the first image signal RGB into the second image signal RGB′ based on the first sensing signal LS1 and the second sensing signal LS2 and the first image signal RGB. The look-up table 130 may be configured to include a non-volatile memory. In an example, the look-up table 130 may be configured to be built within the timing controller 120 or disposed outside the transparent display apparatus 100, however, is not limited thereto. Further, in the case that an external memory (not shown) is connected to the transparent display apparatus 100 by using an interface, such as a Universal Serial Bus (USB) port, the look-up table 130 may be embodied using an external memory. In this case, a user may change the relation between the first image signal RGB and the second image signal RGB′, which may be stored in the look-up table 130.

In FIG. 2, the light sensors may be arranged on both of the front window 101 and the rear window 102, but are not limited thereto. More specifically, the light sensors may be arranged on only one of the front window 101 and the rear window 102.

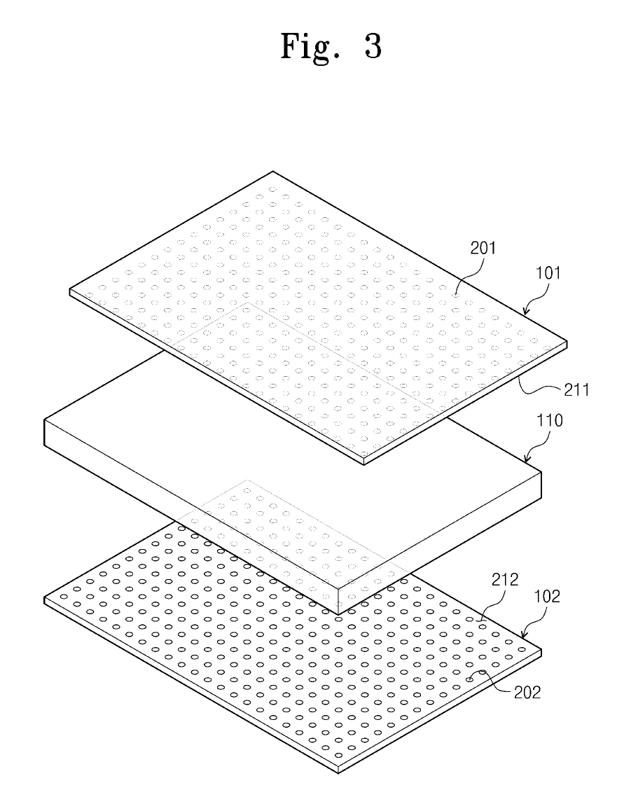

FIG. 3 is a view showing light sensors arranged on a front window and a rear window shown in FIG. 2.

Referring to FIG. 3, the front light sensors 201 are arranged on a first surface 211 of the front window 101 in a matrix form, which is attached to the transparent image panel 110. The rear light sensors 202 are arranged on a first surface 212 of the rear window 102 in a matrix form, which is attached to the transparent image panel 110. In the case that the transparent display apparatus 100 has a full high definition (FHD) resolution and each pixel includes red, green, and blue sub-pixels, 1920×3×1080 sub-pixels may be arranged on the transparent image panel 110. If alight sensor is located at every six sub-pixels in a row direction and at every three sub-pixels in a column direction, number of the front light sensors 201 arranged on the front window 101 and the number of the rear light sensors 202 arranged on the rear window 102 may be 320×3×360. If the transparent image panel 110 is a pentile-type display and each pixel includes red, green, blue, and white sub-pixels, the number of the front light sensors 201 arranged on the front window 101 and the number of the rear light sensors 202 arranged on the rear window 102 may be 320×4×360. The number of the front light sensors 201 and rear light sensors 202 arranged on the front window 101 and the rear window 102 may be varied.

The front light sensors 201 arranged on the front window 101 may sense a visual characteristic, which may include at least one of brightness and color, of the external incident light incident to the first surface 211 of the front window 101 and apply the first sensing signal LS1, which may correspond to at least one of the sensed visual characteristic, to the timing controller 120 shown in FIG. 2.

The rear light sensors 202 arranged on the rear window 102 may sense a visual characteristic, which may include at least one of brightness and color, of the external incident light incident to the first surface 212 of the rear window 102 and apply the second sensing signal LS2, which may correspond to at least one of the sensed visual characteristic, to the timing controller 120 shown in FIG. 2.

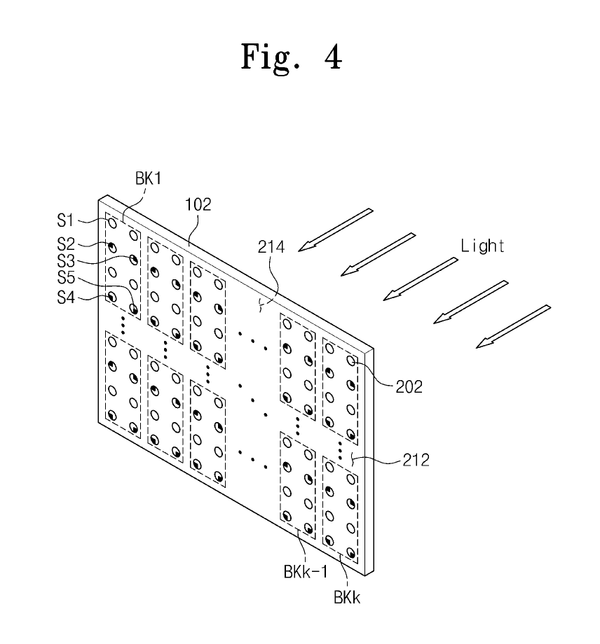

FIG. 4 is a view showing light sensors attached to a rear window shown in FIG. 3.

Referring to FIG. 4, the rear light sensors 202 attached to the first surface 212 of the rear window 102 are arranged in the matrix form. In addition, the rear light sensors 202 are grouped into a plurality of sensor blocks BK1 to BKk. Each of the sensor blocks BK1 to BKk includes eight rear light sensors 202. The sensor block BK1 includes a first type light sensor S1, a second type light sensor S2, a third type light sensor S3, a fourth type light sensor S4, and a fifth type light sensor S5. The first type light sensor S1 may sense a visual characteristic, which may include at least one of brightness and color, of the external incident light incident to a second surface 214 of the rear window 102. The second surface of the rear window 102 may face the first surface 212 of the rear window 102 and may be disposed closer to the rear side of the transparent image panel 110. The sensor block BK1 may include four first type light sensors S1. Since the sensor blocks BK2 to BKk have the same or similar configuration as the sensor block BK1, the configuration and operation of the sensor block BK1 will be described in more detail as an example, and details of the sensor blocks BK2 to BKk will be omitted in order to avoid redundancy.

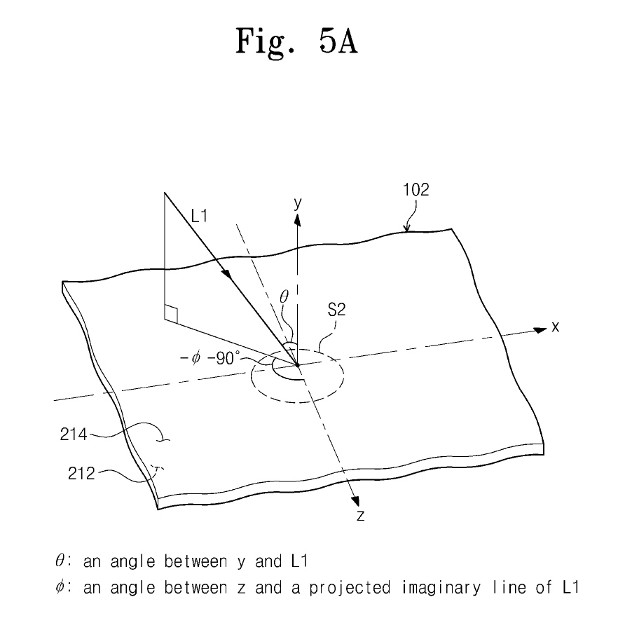

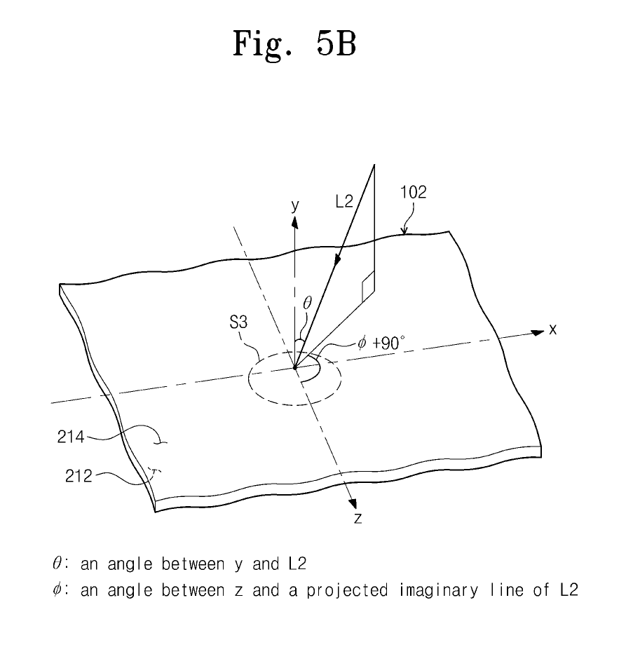

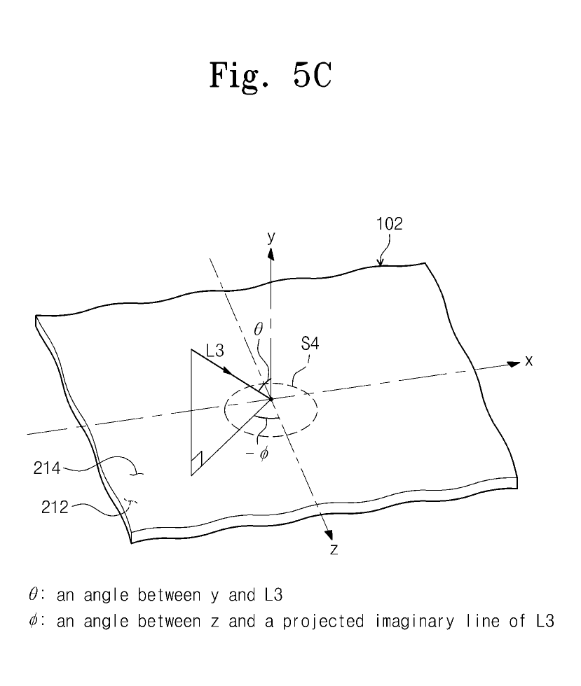

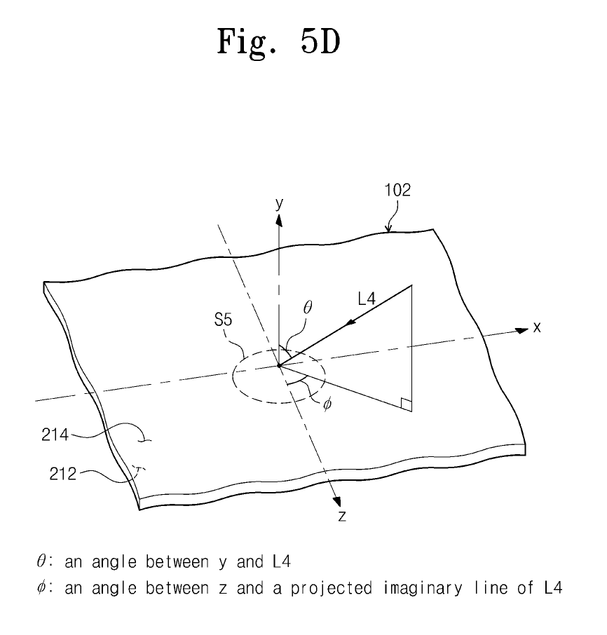

FIG. 5A, FIG. 5B, FIG. 5C, and FIG. 5D are views showing incident angles of external incident lights sensed by a second type light sensor, a third type light sensor, a fourth type light sensor, and a fifth type light sensor shown in FIG. 4.

Referring to FIG. 4 and FIG. 5A, the second type light sensor S2 may sense a visual characteristic, which may include at least one of brightness and color, of the external incident light L1 incident to the second surface 214 of the rear window 102 at an incident angle (Θ, −Φ −90°).

Referring to FIG. 4 and FIG. 5B, the third type light sensor S3 may sense a visual characteristic, which may include at least one of brightness and color, of the external incident light L2 incident to the second surface 214 of the rear window 102 at an incident angle (Θ, −Φ +90°) 900).

Referring to FIG. 4 and FIG. 5C, the fourth type light sensor S4 may sense a visual characteristic, which may include at least one of brightness and color, of the external incident light L3 incident to the second surface 214 of the rear window 102 at an incident angle (Θ, −Φ).

Referring to FIG. 4 and FIG. 5D, the fifth type light sensor S5 may sense a visual characteristic, which may include at least one of brightness and color, of the external incident light L4 incident to the second surface 214 of the rear window 102 at an incident angle (Θ, Φ).

In FIG. 5A, FIG. 5B, FIG. 5C, and FIG. 5D, Θ denotes an angle between the external incident light and a normal line y with respect to the first surface 212 of the rear window 102, and Φ denotes an angle between a straight line z in the first surface 212 and an imaginary line obtained by projecting the external incident light onto the first surface 201.

Referring to FIG. 4 again, since one sensor block BK1 includes the first-type light sensor S1, the second type light sensor S2, the third type light sensor S3, the fourth type S4, and the fifth type light sensor S5, a visual characteristic, which may include at least one of the brightness and the color, of the lights incident at various angles may be sensed. Therefore, the front and background colors of the transparent display apparatus 100 may be sensed at various positions of the viewer.

For instance, in the case that the angle Θ is about 45 degrees and the angle Φ is about 45 degrees, the second type light sensor S2 may sense a visual characteristic, which may include at least one of brightness and color, of the external incident light L1 incident to the second surface 214 of the rear window 102 at the incident angle (45°, −135°. The third type light sensor S3 may sense a visual characteristic, which may include at least one of brightness and color, of the external incident light L2 incident to the second surface 214 of the rear window 102 at the incident angle (45°, 135°). The fourth type light sensor S4 may sense a visual characteristic, which may include at least one of brightness and color, of the external incident light L3 incident to the second surface 214 of the rear window 102 at the incident angle (45°, −45°. The fifth type light sensor S5 may sense a visual characteristic, which may include at least one of brightness and color, of the external incident light L4 incident to the second surface 214 of the rear window 102 at the incident angle (45°, 45°).

FIG. 4, FIG. 5A, FIG. 5B, FIG. 5C, and FIG. 5D illustrate operations of the rear light sensors 202 attached to the rear window 102, but the front light sensors 201 attached to the front window 101 may sense the external incident light by using the same or similar principle as the rear light sensors 202 attached to the rear window 102.

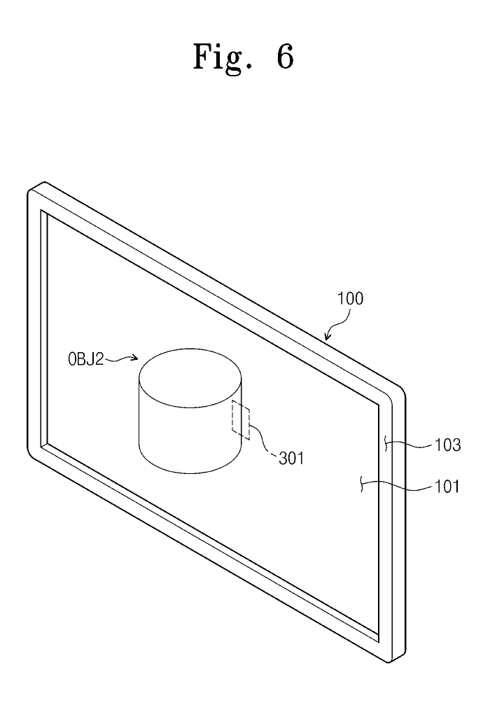

FIG. 6 is a view showing a display object displayed through a transparent display apparatus.

Referring to FIG. 6, if a display object OBJ2 displayed through the transparent display apparatus 100 has a white color and the background of the transparent display apparatus 100 is of a similar or same white color, the display object OBJ2 may be difficult to be distinguished from the background. As described above, if the gray scale value of the display object OBJ2 displayed through the transparent display apparatus 100 is equal or similar to a gray scale value of a sensing signal corresponding to the external incident light incident to the transparent display apparatus 100 displaying the display object OBJ2, the gray scale value corresponding to an outline of the display object OBJ2 may be changed. Thus, the viewer may perceive the display object OBJ2 to be distinguishable from the background of the transparent display apparatus 100.

Further, if the gray scale value of the display object OBJ2 displayed through the transparent display apparatus 100 is equal to a gray scale value of a sensing signal corresponding to the external incident light incident to the transparent display apparatus 100 displaying the display object OBJ2, the gray scale value corresponding to at least a portion of the display object OBJ2 may be changed. Alternatively, if the gray scale value of the display object OBJ2 displayed through the transparent display apparatus 100 is equal to a gray scale value of a sensing signal corresponding to the external incident light incident to the transparent display apparatus 100 displaying the display object OBJ2, the gray scale value corresponding to remaining pixels other than the display object OBJ2 may be changed. Accordingly, the display object OBJ2 may be more distinguishable from the background of the transparent display apparatus 100 by changing the gray scale values.

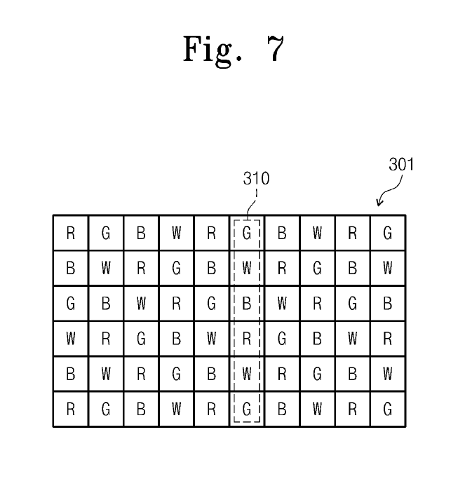

FIG. 7 is a plan view showing sub-pixels of a transparent image panel corresponding to a portion of the display object shown in FIG. 6.

Referring to FIG. 7, the sub-pixels of the transparent image panel 110 shown in FIG. 2 are arranged in a pentile RGBW structure. In an example, a pixel having the pentile RGBW may include red R, green G, blue B, and white W sub pixels. Further, the respective pixel may display a white color when the red R, green G, blue B, and white W sub-pixels are turned on.

The timing controller 120 shown in FIG. 2 may output the second image signal RGB′ on the basis of the first image signal RGB from an external device (not shown) and the first sensing signal LS1 and the second sensing signal LS2 from the front light sensor 201 and the rear light sensor 202. If the gray scale value indicated by the first sensing signal LS1 and the second sensing signal LS2 is similar to the gray scale value of the display object OBJ2 in the first image signal RGB, the timing controller 120 may change the gray scale value of the image data corresponding to the outline of the display object OBJ2 and output the second image signal RGB′. In this case, the gray scale value of the image data corresponding to the outline of the display object OBJ2 may be changed in one or more sub-pixels.

More specifically, among the sub-pixels of the transparent image panel 110, in which a portion 301 of the display object OBJ2 may be displayed, the gray scale value of the sub-pixels 310 corresponding to the outline of the display object OBJ2 may be changed. Thus, the viewer may more clearly perceive the display object OBJ2 regardless of the color of the background.

In the case that the sub-pixels of the transparent image panel 110 are arranged in the pentile RGBW structure, the timing controller 120 may generate a gray scale signal in the white W subpixel of the first image signal RGB to provide the second image signal RGB′, which may include the red R, green G, blue B, and white W subpixels, which may be changed to have gray scale value.

In FIG. 7, the sub-pixels of the transparent image panel 110 are arranged in the pentile RGBW structure, but are not limited thereto. More specifically, a pixel of the transparent image panel 110 may also include only red R, green G, and blue B sub-pixels. In this case, the gray scale value of the image data corresponding to the outline of the display object OBJ2 may be changed with respect to the gray scale value of the display object OBJ2 and the gray scale value of the external incident light incident to the transparent display apparatus 100.

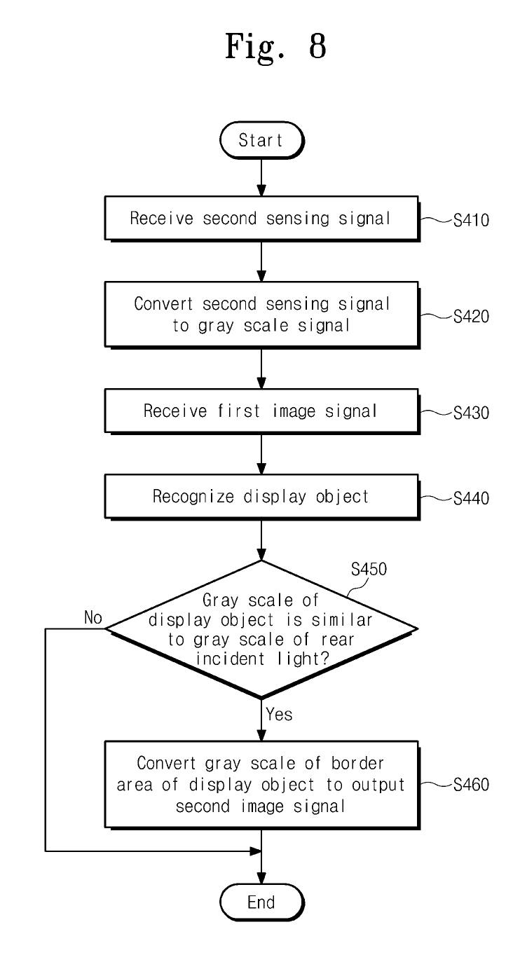

FIG. 8 is a flow chart showing an operation of the timing controller shown in FIG. 2 according to an exemplary embodiment of the present invention.

In FIG. 8, the timing controller 120 may receive one of the first sensing signal LS1 and the second sensing signal LS2. The timing controller 120 may receive the second sensing signal LS2 from the light sensors 202 disposed on the rear window 102.

Referring to FIG. 8, the timing controller 120 receives the second sensing signal LS2 from the rear light sensors 202 disposed on the rear window 102 (S410). The second sensing signal LS2 may include the information of the external incident light, such as brightness, color, and the like, incident to the rear window 102.

The timing controller 120 converts the second sensing signal LS2 into a gray scale signal (S420). The second sensing signal LS2 may be converted to the gray scale corresponding to red R, green G, and blue B on the basis of the look-up table 130. The timing controller 120 may output the gray scale signal corresponding to the second sensing signal LS2 on the basis of the look-up table. The second sensing signal LS2 may be converted to have the same or similar gray scale range as that of the first image signal RGB.

For instance, if the first image signal RGB has a range of 256 gray scales, the second sensing signal LS2 may be converted to the gray scale signal having the range of 256 gray scales. The timing controller 120 receives the first image signal RGB from the external device (not shown) (S430). The first image signal RGB may be stored in an inner memory (not shown) in a unit of a frame. The timing controller 120 recognizes the display object OBJ2 shown in FIG. 6 through the first image signal RGB of one frame (S440).

If the first image signal RGB corresponding to the display object OBJ2 is similar to the gray scale signal obtained by converting the second sensing signal LS2 (S450), the timing controller 120 converts the first image signal RGB corresponding to the gray scale value of the outline of the display object OBJ2 to the second image signal RGB′ on the basis of the look-up table 130 and outputs the second image signal RGB′ (S460).

In more detail, if a gray scale value difference between the first image signal RGB corresponding to the display object OBJ2 and the gray scale signal obtained by converting the second sensing signal LS2 is equal to or smaller than a reference level (e.g., three gray scale levels), the timing controller 120 may determine that the first image signal RGB corresponding to the display object OBJ2 is similar to the gray scale signal obtained by converting the second sensing signal LS2.

Therefore, as shown in FIG. 6 and FIG. 7, although the gray scale value of the display object OBJ2 may be similar to the color of the background of the transparent image panel 110, the viewer can perceive the display object OBJ2 separately from the background of the transparent image panel 110.

For example, if the gray scale value of the display object OBJ2 is a 256 level gray scale, which may correspond to the gray scale signal of the external incident light incident to the rear surface of the transparent display apparatus 100 having a 254 level gray scale, the timing controller 120 may change the gray scale value of the first image signal RGB corresponding to the outline of the display object OBJ2 on the basis of the look-up table 130 to output the second image signal RGB′. As an example, the first image signal RGB of 256 gray levels may be converted to the second image signal RGB′ of 252 gray levels.

As the above-mentioned method, the gray scale value of the image data corresponding to the outline of the display object OBJ2 may be changed when the color of the display object OBJ2 is similar to the background of the transparent display apparatus 100.

According to exemplary embodiments, the operation shown in FIG. 8 may be performed by the timing controller shown in FIG. 2, but is not limited thereto. For example, the operation shown in FIG. 8 may be performed by an image processing processor in the case that the transparent display apparatus 100 includes a separate image processor.

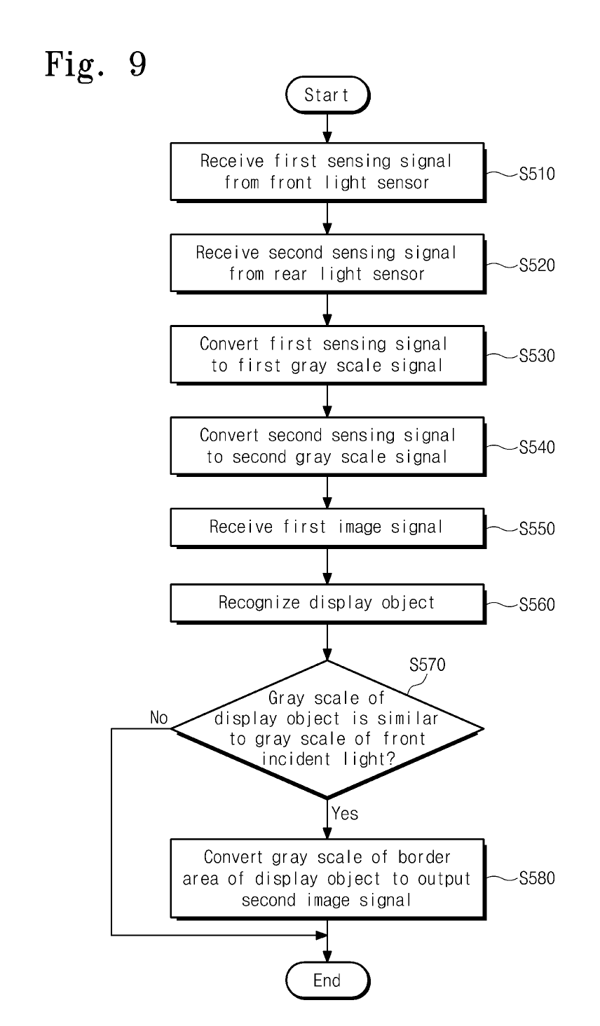

FIG. 9 is a flow chart showing an operation of the timing controller shown in FIG. 2 according to an exemplary embodiment of the present invention.

Referring to FIG. 2, FIG. 3, FIG. 4, FIG. 5, FIG. 6, FIG. 7, FIG. 8, and FIG. 9, the timing controller 120 receives the first sensing signal LS1 from the front light sensors 201 disposed on the front window 101 (S510). In addition, the timing controller 120 receives the second sensing signal LS2 from the rear light sensors 202 disposed on the rear window 102 (S520).

The timing controller 120 converts the first sensing signal LS1 to a first gray scale signal (S530) and converts the second sensing signal LS2 to a second gray scale (S540). The first sensing signal LS1 and the second sensing signal LS2 having information of at least one of brightness and color of a display object and a background may be converted to the grays scale signals corresponding to red R, green G, and blue B by the look-up table (not shown). The timing controller 120 may output the gray scale signal corresponding to the second sensing signal LS2 on the basis of the look-up table 130. In this case, each of the first sensing signal LS1 and the second sensing signal LS2 may be converted to have the same gray scale range as that of the first image signal RGB provided from the external device (not shown). For instance, if the first image signal RGB has a range of 256 gray scales, the first sensing signal LS1 and the second sensing signal LS2 may be respectively converted to the first gray scale signal and the second gray scale signal having the range of 256 gray scales.

The timing controller 120 receives the first image signal RGB from the external device (S550). The first image signal RGB may be stored in an inner memory (not shown) in a unit of a frame. The timing controller 120 recognizes the display object OBJ2 shown in FIG. 6 through the first image signal RGB of the frame (S560).

When the first image signal RGB corresponding to the display object OBJ2 is similar to one of the first gray scale signal, which may be obtained by converting the first sensing signal LS1, and the second gray scale signal, which may be obtained by converting the second sensing signal LS2 (S570), the timing controller 120 converts the first image signal RGB corresponding to the gray scale value of the outline or a border area of the display object OBJ2 to the second image signal RGB′ on the basis of the look-up table 130 and outputs the second image signal RGB′ (S580).

According to exemplary embodiments, when the gray scale value of the display object OBJ2 is similar to the first gray scale signal obtained by converting the first sensing signal LS1 or the second gray scale signal obtained by converting the second sensing signal LS2, the timing controller 120 may change the gray scale value of the image data corresponding to the outline of the display object OBJ2. Further, the timing controller 120 may also be designed to change gray scale values of the entire display object OBJ2, which may include the gray scale value of the outline of the display object OBJ2.

In more detail, when a gray scale value difference between the first image signal RGB corresponding to the display object OBJ2 and the second gray scale signal obtained by converting the second sensing signal LS2 is equal to or smaller than a reference level (e.g., three gray scale levels), the timing controller 120 may determine that the first image signal RGB corresponding to the display object OBJ2 is similar to the second gray scale signal, which may be obtained by converting the second sensing signal LS2.

In the case that the first image signal RGB is a moving image, the timing controller 120 may receive the first signal LS1 and the second sensing signal LS2 from the front light sensor 201 and the rear light sensor 202 at every Q-th frame. More specifically, the timing controller 120 may receive the first sensing signal LS1 and the second sensing signal LS2 from the front light sensor 201 and the rear light sensor 202 at one or more reference periods and compares the gray scale value of the display object OBJ2 with the first sensing signal LS1 and the second sensing signal LS2 at one or more frames with reference to the received first sensing signal LS1 and second sensing signal LS2. In general, since the background of the transparent display apparatus 100 may be changed more slowly than a frame frequency of the first image signal RGB that may be a moving image, inconveniences to the viewer may be reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A transparent display apparatus, comprising:
a transparent image panel comprising a plurality of sub-pixels;
a data driver configured to apply a data signal to the sub-pixels;
a gate driver configured to apply a gate driving signal to the sub-pixels;
a timing controller configured to control the data driver and the gate driver in response to a first image signal; and
a window disposed on a surface of the transparent image panel and comprising a plurality of light sensors arranged thereon,
wherein at least one of the light sensors senses an external incident light and applies a sensing signal corresponding to the sensed external incident light to the timing controller, and the timing controller applies a second image signal to the data driver based on the sensing signal and the first image signal.

2. The transparent display apparatus of claim 1, wherein the at least one of the light sensors senses a visual characteristic of the external incident light and outputs the sensing signal corresponding to the sensed visual characteristic.

3. The transparent display apparatus of claim 2, wherein the visual characteristic comprises at least one of a brightness and color.

4. The transparent display apparatus of claim 2, wherein the timing controller converts the sensing signal into a gray scale signal, recognizes a display object based on the first image signal, modify a gray scale value corresponding to a portion of the display object to generate the second image signal if the gray scale value is determined to be similar to the gray scale signal, and outputs the second image signal.

5. The transparent display apparatus of claim 4, wherein the second image signal is outputted by modifying the gray scale value corresponding to the outline of the display object.

6. The transparent display apparatus of claim 4, further comprising a look-up table that stores the gray scale value corresponding to the portion of the display object, wherein the timing controller outputs the second image signal with reference to the look-up table if the gray scale value of the display object is determined to be similar to the gray scale signal.

7. The transparent display apparatus of claim 4, wherein the timing controller outputs the second image signal if the display object comprises a reference color and the gray scale signal indicates a color similar to the reference color.

8. The transparent display apparatus of claim 2, wherein the light sensors are arranged on a first surface of the window in a matrix form.

9. The transparent display apparatus of claim 8, wherein the light sensors are grouped into a plurality of sensor blocks, and each of the sensor blocks comprises at least one of a first type light sensor, a second type light sensor, a third type light sensor, a fourth type light sensor, and a fifth type light sensor to sense the visual characteristic of the external incident light incident in different directions.

10. The transparent display apparatus of claim 9, wherein the first type light sensor senses the visual characteristic of the external incident light that is incident to the first surface of the window, the second type light sensor senses the visual characteristic of the external incident light that is incident to the first surface of the window at a first incident angle, the third type light sensor senses the visual characteristic of the external incident light that is incident to the first surface of the window at a second incident angle, the fourth type light sensor senses the visual characteristic of the external incident light that is incident to the first surface of the window at a third incident angle, and the fifth type light sensor senses the visual characteristic of the external incident light incident to the first surface of the window at a fourth incident angle.

11. The transparent display apparatus of claim 10, wherein
the first incident angle has values of Θ, −Φ −90°,
the second incident angle has values of Θ, −Φ −90°,
the third incident angle has values of Θ, −Φ,
the fourth incident angle has values of Θ, Φ,
wherein where Θ denotes an angle between the external incident light and a normal line with respect to the first surface of the window and Φ denotes an angle between a reference line in the first surface and an imaginary line obtained by projecting the external incident light onto the first surface.

12. The transparent display apparatus of claim 1, wherein the window comprises:
a first window disposed at a first portion of the transparent image panel and comprising a plurality of first light sensors arranged thereon; and
a second window disposed at a second portion of the transparent image panel and comprising a plurality of second light sensors arranged thereon.

13. The transparent display apparatus of claim 12, wherein the timing controller applies the second image signal to the data driver based on a first sensing signal received from the first light sensors, a second sensing signal received from the second light sensors, and the first image signal.

14. The transparent display apparatus of claim 1, wherein the sub-pixels of the transparent image panel comprises a red subpixel, a green subpixel, a blue subpixel, and a white subpixel.

15. A method for distinguishing a display object provided on a transparent display apparatus, comprising:
receiving a sensing signal corresponding to an external incident light from a plurality of light sensors;
converting the sensing signal to a gray scale signal using a processor;
receiving a first image signal;
determining the display object from the first image signal; and
converting the first image signal to a second image signal based on a gray scale value of the display object and the gray scale signal.

16. The method of claim 15, wherein at least one of the light sensors senses a visual characteristic of the external incident light and outputs the sensing signal corresponding to the sensed visual characteristic.

17. The method of claim 16, wherein the sensed visual characteristic comprises at least one of a brightness and color.

18. The method of claim 15, wherein the converting of the first image signal to the second image signal comprises converting the first image signal to the second image signal if the gray scale value of the display object is determined to be similar to the gray scale signal.

19. The method of claim 15, wherein the converting of the first image signal to the second image signal comprises converting a gray scale value corresponding to an outline of the display object if the display object comprises a reference color and the gray scale signal indicates a color similar to the reference color.

20. The method of claim 15, wherein receiving the sensing signal from the plurality of light sensors comprise:
receiving a first sensing signal from a plurality of first light sensors, the sensing signal corresponding to the external incident light incident to a first surface of a transparent image panel; and
receiving a second sensing signal from a plurality of second light sensors, the second sensing signal corresponding to the external incident light incident to a second surface of the transparent image panel.

21. The method of claim 15, further comprising applying the second image signal to a data driver.

22. A method for displaying an object on a transparent display, the method comprising:
receiving a first image signal comprising information for displaying an object;
sensing a light incident on a rear surface of the transparent display;
comparing a visual characteristic of the object to be displayed with a visual characteristic of the light incident on the rear surface of the display;
modifying the visual characteristic of the object to be displayed when the visual characteristic of the object to be displayed is equal to or within a threshold amount of the visual characteristic of the light incident on the rear surface of the display; and
displaying the object using the modified visual characteristic.

23. The method of claim 22, wherein the visual characteristic of the object to be displayed is a gray scale level of the object.
